(19) United States
(12) Patent Application Publication
(10) Pub. No.: US 2019/0161019 A1
(43) Pub. Date: May 30, 2019

(54) DAMPER ASSEMBLIES

(71) Applicant: Illinois Tool Works Inc., Glenview, IL (US)

(72) Inventors: Steven L. Bivens, Kankakee, IL (US); Michael Adrian Tyler, Mokena, IL (US); Daniel Timothy Lindsey, Tinley Park, IL (US); Taher Ammar Rangwala, Orland Park, IL (US); Michael James Tenuta, Mount Pleasant, WI (US)

(73) Assignee: Illinois Tool Works Inc., Glenview, IL (US)

(21) Appl. No.: 16/191,673

(22) Filed: Nov. 15, 2018

Related U.S. Application Data
(60) Provisional application No. 62/592,738, filed on Nov. 30, 2017.
(60) Provisional application No. 62/626,194, filed on Feb. 5, 2018.

(51) Int. Cl. B60R 7/06; E05F 3/14; F16F 9/00; F16F 9/32; F16F 9/02; B60Q 3/82

(52) U.S. Cl. CPC B60R 7/06; E05F 3/14; F16F 9/003; E05Y 2900/538; F16F 9/02; B60Q 3/82; E05Y 2201/21; F16F 9/3207

(57) ABSTRACT

A system includes a fixed body and a cover moveably secured to the fixed body. The cover is configured to be moved between a closed position and an open position in relation to the fixed body. The system also includes a damper system including a damper assembly having a damping mechanism coupled to the fixed body and the cover. The damping mechanism is configured to dampen motion between the cover and the fixed body. The damper assembly further includes a housing coupled to the damping mechanism and a switch. The damper assembly further includes a power source and a switch. A lighting device is coupled to the power source. A portion of the damping mechanism is configured to interact with the switch to activate and deactivate the lighting device.

### RELATED APPLICATIONS

This application relates to and claims priority benefits from U.S. Provisional Patent Application No. 62/592,738, entitled “Independently-Powered Light-Emitting Damper Assembly,” filed November 30, 2017, which is hereby incorporated by reference in its entirety.

This application also relates to and claims priority benefits from U.S. Provisional Patent Application No. 62/626,194, entitled “Damper Assembly Having A Switch,” filed Feb. 5, 2018, which is hereby incorporated by reference in its entirety.

### FIELD OF EMBODIMENTS OF THE DISCLOSURE

Embodiments of the present disclosure generally relate to damper assemblies configured for use with a compartment, and more particularly, to damper assemblies configured to control motion between a cover and a housing of a compartment, such as a glove box within a vehicle.

### BACKGROUND

Various compartments are configured to be selectively opened and closed. For example, a glove box or compartment within a vehicle is configured to be opened so that one or more items may be stored therein, and then closed to securely retain the item(s). A typical glove box includes a main fixed housing and a cover (such as a door, panel, lid, or the like) that is moveably secured to the fixed housing between an open position and a closed position. For example, the cover may be pivotally secured to the fixed housing. The cover includes a securing member, such as a latch, that cooperates with a complementary structure of the fixed housing to ensure that the cover is secured in the closed position.

Various glove boxes include a damper that controls motion of the door in relation to the housing. A first portion of the damper is attached to the housing, while another portion of the damper is attached to the moveable door.

Linear dampers resist motion in a defined direction. Certain linear dampers may include a switch that is coupled to a separate and distinct light within a glovebox. Typically, the switch is electrically connected to a separate and distinct power source within a vehicle (such as a battery within an engine compartment) via wiring that is routed between the switch and the power source. When the glovebox is opened, the switch activates to draw power from the separate and distinct power source, which is then delivered to the separate and distinct light within the glovebox, in order to illuminate the interior of the glovebox.

As can be appreciated, the manufacturing process for installing the damper may be time and labor intensive. In particular, the switch of the damper is electrically coupled to the separate and distinct power source and the separate and distinct light through wiring that is routed between the separate and distinct components.

### SUMMARY OF EMBODIMENTS OF THE DISCLOSURE

Some embodiments of the present disclosure provide a damper system that includes a damper assembly including a damping mechanism that is configured to dampen motion between a first portion and a second portion of a component. A housing is coupled to the damping mechanism. The damper system also includes a switch and a power source. A lighting device is coupled to the power source. A portion of the damping mechanism is configured to interact with the switch to activate and deactivate the lighting device.

In at least one embodiment, the damper assembly includes the power source. In at least one embodiment, the damper assembly includes the lighting device. In at least one embodiment, the damper assembly includes the power source and the lighting device.

The housing may contain the power source. The lighting device may be coupled to the housing. The lighting device may be powered by the power source.

In at least one embodiment, the lighting device is configured to be activated to emit light when the first portion is opened in relation to the second portion. The lighting device is configured to be deactivated when the first portion is closed in relation to the second portion.

The damping mechanism may include a rack that is configured to be secured to one of the first portion or the second portion, and a carriage moveably secured to the rack. The carriage may be configured to be secured to the other of the first portion or the second portion.

A spring may be retained within the rack. The spring exerts a resistive force into the end of the carriage. In at least one embodiment, the spring is an extension spring that is configured to exert a spring force towards an end of the rack. In at least one embodiment, the spring is configured to drive actuation of the switch.

A strand may be coupled to the carriage and an anchor that is configured to be secured to the other of the first portion of the second portion. The carriage may include a strand coupler including a first passage separated from a second passage by a wall. The strand loops through the first passage and the second passage.

The carriage may include a ramp outwardly extending from a side of the carriage. The ramp is configured to engage a portion of the switch. The ramp may extend over more than half a length of a side of the carriage.

Certain embodiments of the present disclosure provide a system including a fixed body, and a cover moveably secured to the fixed body. The cover is configured to be moved between a closed position and an open position in relation to the fixed body. A damper system includes a damper assembly including a damping mechanism coupled to the fixed body and the cover. The damping mechanism is configured to dampen motion between the cover and the fixed body. The damper assembly further includes a housing coupled to the damping mechanism, a switch, and a power source. A lighting device is coupled to the power source. A portion of the damping mechanism is configured to interact with the switch to activate and deactivate the lighting device.

In at least one embodiment, the damper assembly includes the power source. In at least one embodiment, the damper assembly includes the lighting device. In at least one embodiment, the damper assembly includes the power source and the lighting device.

### BRIEF DESCRIPTION OF SEVERAL VIEWS OF THE DRAWINGS

FIG. 1A illustrates a schematic block diagram of a damper system.

FIG. 1B illustrates a schematic block diagram of a damper assembly.

FIG. 2 illustrates a front view of the damper assembly of FIG. 1B in a closed position.

FIG. 3 illustrates a lateral view of the damper assembly in a closed position.

FIG. 4 illustrates a front view of the damper assembly in an open position.

FIG. 5 illustrates a perspective view of a lighting device of the damper assembly.

FIG. 6 illustrates a rear view of the damper assembly in an open position.

FIG. 7 illustrates an inner view of the damper assembly secured to a component in a closed position.

FIG. 8 illustrates an inner view of the damper assembly secured to the component in an open position.

FIG. 9 illustrates a perspective view of the lighting device of the damper assembly within an interior chamber of the component.

FIG. 10 illustrates a front view of a damper assembly.

FIG. 11 illustrates a perspective front view of a damper assembly.

FIG. 12 illustrates a front view of a damper assembly.

FIG. 13 illustrates a front view of a ramp of a carriage engaging a switch of a housing of the damper assembly.

FIG. 14 illustrates a perspective exploded view of a damper assembly.

FIG. 15 illustrates a perspective front view of the damper assembly of FIG. 14.

FIG. 16 illustrates a cross-sectional view of the damper assembly through line 16-16 of FIG. 15.

FIG. 17 illustrates a rear view of a damper assembly in an open position.

Before the embodiments of the disclosure are explained in detail, it is to be understood that the disclosure is not limited in its application to the details of construction and the arrangement of the components set forth in the following description or illustrated in the drawings. The disclosure is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION OF EMBODIMENTS OF THE DISCLOSURE

Certain embodiments of the present disclosure provide a damper assembly coupled to a power source and lighting device. In at least one embodiment, the damper assembly is configured to be independently powered and independently emit light. In at least one embodiment, the damper assembly includes a housing that contains a power source (such as a battery) that is electrically coupled to one or more lighting devices (such as a light emitting diode). The housing provides a mount that is configured to be secured to a component (such as a glove box).

In at least one embodiment, the lighting device(s) are configured to protrude into an internal chamber of the component and illuminate the internal chamber when the component is in an open position. Because the power source may be contained within the housing of the damper assembly, there is no need to couple the damper assembly to a separate and distinct power source, for example. In this manner, the damper assembly allows for an efficient, simplified, and time-saving manufacturing process. The damper assembly is configured to independently provide motion-damping, power, and illumination.

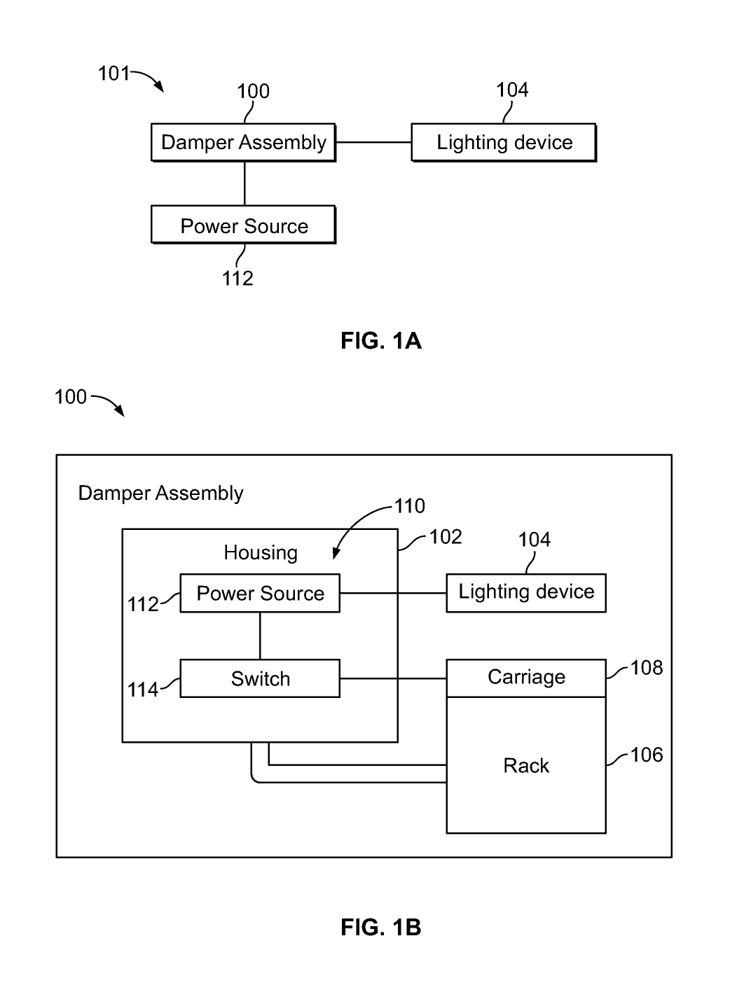

FIG. 1A illustrates a schematic block diagram of a damper system 101, according to an embodiment of the present disclosure. The damper system 101 includes a damper assembly 100, a lighting device 104, and a power source 112.

In at least one embodiment, the damper assembly 100 includes the lighting device 104 and the power source 112. For example, the lighting device 104 and the power source 112 may be on or within portions of the damper assembly 100. For example, the power source 112 may be within a housing 102 (shown in FIG. 1B), while the lighting device 104 is connected to the housing 102.

In at least one other embodiment, the lighting device 104 may be separate and distinct from the damper assembly 100. For example, the lighting device 104 may be on or within a component (such as a glove box) other than the damper assembly 100.

In at least one other embodiment, the power source 112 may be separate and distinct from the damper assembly 100. For example, the power source 112 may be on or within a component other than the damper assembly 100.

FIG. 1B illustrates a schematic block diagram of the damper assembly 100, according to an embodiment of the present disclosure. The damper assembly 100 includes the housing 102 that supports one or more lighting devices 104. For example, the lighting device(s) 104 may extend outwardly from the housing 102. In at least one other embodiment, at least a portion of the lighting device(s) 104 may be within the housing 102. In at least one other embodiment, the lighting device(s) 104 may be remotely located from and connected to the housing 102 through wiring, for example. The housing 102 is coupled to a rack 106 that supports a damping carriage 108, which is configured to move over, within, and/or on the rack 106. The carriage 108 may include a damping media, such as a fluid, that is retained therein. For example, the carriage 108 may include an internal rotor that is configured to engage the rack 106, such as in a gear-like fashion. A viscous fluid may be contained within the carriage 108, and may surround at least a portion of the rotor, for example. The carriage 108 interacts with the rack 106 to provide linear damping, for example. The rack 106 and the carriage 108 cooperate to provide a damping mechanism.

Alternatively, the damper assembly 100 may not include the rack 106 and the carriage 108. Instead, the damper assembly 100 may be configured to dampen motion through other structures and features. For example, instead of the rack 106 and the carriage 108, the damping mechanism of the damper assembly 100 may include one or more rotary, elastomeric, springs, and/or the like that are configured to dampen motion. In at least one embodiment, the damper assembly 100 may be a pneumatic or air damper. For example, the damper assembly 100 may be an air damper including or otherwise coupled to the lighting device 104 and the power source 112.

The housing 102 defines an interior chamber 110 that retains a power source 112. The power source 112 is electrically coupled to a switch 114 and the lighting device(s) 104 through an electrical wire, for example. In at least one embodiment, the power source 112 is electrically coupled to the switch 114 and the lighting device(s) 104 through one or more electrical wires within the housing 102.

The power source 112 may be a battery. For example, the power source 112 may be a Lithium battery. In at least one other embodiment, the power source 112 may be another type of battery. As another example, the power source 112 may be one or more solar cells.

The carriage 108 is configured to securely mount to a first portion of a component, such as a fixed interior housing wall of a glovebox, while the rack 106 is configured to securely mount to a second portion of the component, such as moveable cover (for example, a door, panel, lid, or the like) of the glovebox. Optionally, the carriage 108 may be configured to mount to the cover of the glovebox, while the rack 106 is configured to mount to the fixed interior housing.

Optionally, the housing 102 may not include the power source 112. Instead, the damper assembly 100 may be coupled to a separate and distinct power source, such as may be within a vehicle. For example, a separate and distinct power source may be electrically coupled to the switch 114 and the lighting device(s) 104 through one or more electrical wires. The separate and distinct power source may be a separate and distinct battery, such as within a vehicle. In at least one embodiment, the housing 102 may include the power source 112 and be coupled to the separate and distinct power source. In such an embodiment, the power source 112 and the separate and distinct power source may provide power redundancy. For example, the power source 112 may provide a power backup to the separate and distinct power source, or vice versa.

Optionally, the damper assembly 100 may not include the lighting device 104. In this embodiment, the damper assembly 100 may be independently powered through the power source 112 and may further be electrically coupled to a separate and distinct lighting device, which may be an existing lighting device within a glovebox, for example. In this embodiment, the damper assembly 100 may not include a lighting device, but instead be coupled to a separate and distinct lighting device that is remote (that is, not on or within) the damper assembly 100. Optionally, the damper assembly 100 may include the lighting device 104, as well as be coupled to a separate and distinct lighting device.

The switch 114 is operatively coupled to the carriage 108. When the carriage 108 is in a first position, the switch 114 is opened, thereby breaking an electrical circuit with the power source 112, such that power is not delivered to the lighting device(s) 104. When the carriage 108 is in a second position that differs from the first position, the switch 114 is closed, thereby completing the electrical circuit with the power source 112, such that power is delivered from the power source 112 to the lighting device(s) 104, thereby illuminating the lighting device(s) 104.

In operation, the carriage 108 moves over the rack 106 as the component is opened and/or closed, in order to dampen (for example, decelerate, slow, or otherwise control) the opening and/or closing of the component. The carriage 108 may engage (or be disengaged from) the switch 114 when the component is closed. In this position, the switch 114 may be in an open position, such that the electrical circuit between the power source 112 and the lighting device(s) 104 is not completed. As the component is opened, the carriage 108 moves over the rack 106 and disengages from (or optionally engages) the switch 114, which then closes to complete the electrical circuit between the power source 112 and the lighting device(s) 104. In this manner, the lighting device(s) 104 emit light into the internal chamber of the component when the component is opened.

As described herein, the damper assembly 100 includes a damping mechanism (such as the rack 106 and the carriage 108) that is configured to dampen motion between a first portion and a second portion of a component. The housing 102 is coupled to the damping mechanism. In at least one embodiment, the housing 102 contains the power source 112. That is, the power source 112 may be an integral part of the damper assembly 100. The lighting device 104 is coupled to the housing 102 and is powered by the power source 112. The housing 102 may also include the switch 114. A portion of the damping mechanism (such as a portion of the carriage 108) is configured to interact with the switch 114 to activate the lighting device 104 (such that the lighting device 104 emits light), and deactivate the lighting device 104 (such that the lighting device 104 does not emit light).

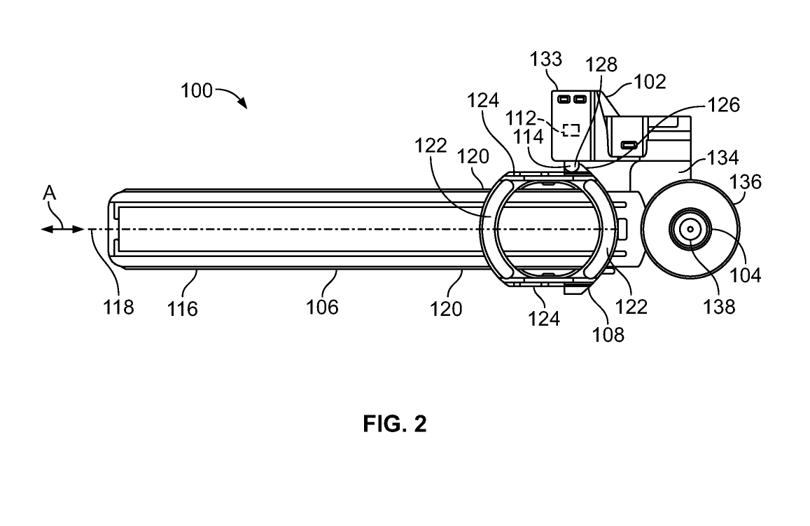

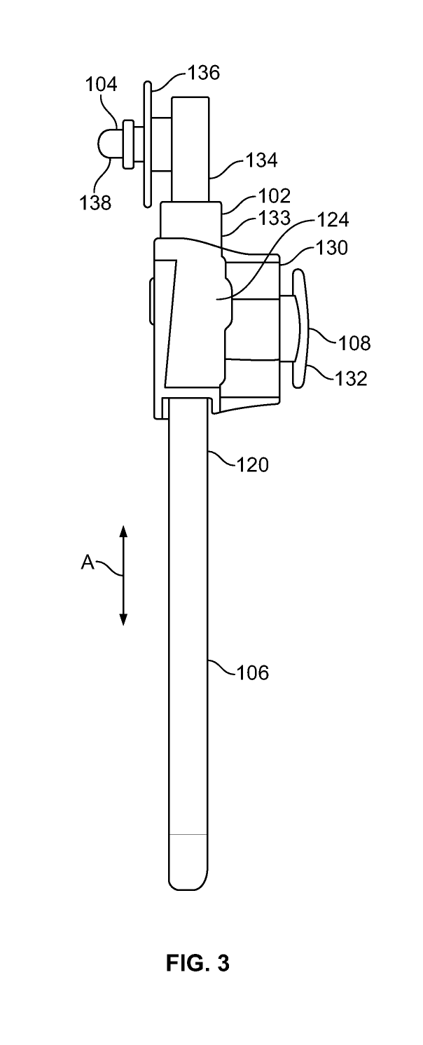

Referring to FIGS. 2 and 3, which depict the damper assembly 100 in a closed position that corresponds to a closed position of a component (such as a glove box) to which the damper assembly 100 is securely coupled, the rack 106 includes a linear beam 116 having a longitudinal axis 118. The rack 106 may include one or more tracks 120 that are operatively engaged by the carriage 108. The carriage 108 may include outer walls 122 that are positioned over the rack 106. The outer walls 122 connect to lateral walls 124. A protuberance 126 (such as a tab, stud, fin, or the like) extends laterally from a lateral wall 124 proximate to the housing 102. In the closed position, the protuberance 126 connects to an engagement portion 128 (such as a deflectable beam, tab, fin, or other such portion) of the switch 114. The connection between the protuberance 126 and the engagement portion 128 causes the switch 114 to be in a first position, in which the electrical connection between the power source 112 and the lighting device 104 is not completed, such that electrical power from the power source 112 is not delivered to the lighting device 104.

As shown in FIG. 3, in particular, the carriage 108 also includes an inner body 130 that connects to the lateral walls 124. The inner body 130 may include a fastening mount 132 (such as a clip, bearing surface, and/or the like) that is configured to securely fasten to a reciprocal portion of a component, such as a glovebox. In at least one some embodiments, the inner body 130 may not include the fastening mount 132. For example, the inner body 130 may be secured to the component through one or more fasteners (such as screws or bolts), adhesives, and/or the like.

The housing 102 includes a case 133 that defines the interior chamber 110 (shown in FIG. 1B). In at least one embodiment, the power source 112 is contained within the case 133. The case 133 couples to the lighting device 104 through a connection beam 134. The lighting device 104 may include a support base 136 that outwardly extends past outer surfaces of the rack 106 and the carriage 108. The support base 136 supports a light-emitting element 138, such as an LED, an incandescent bulb, a fluorescent bulb, and/or the like.

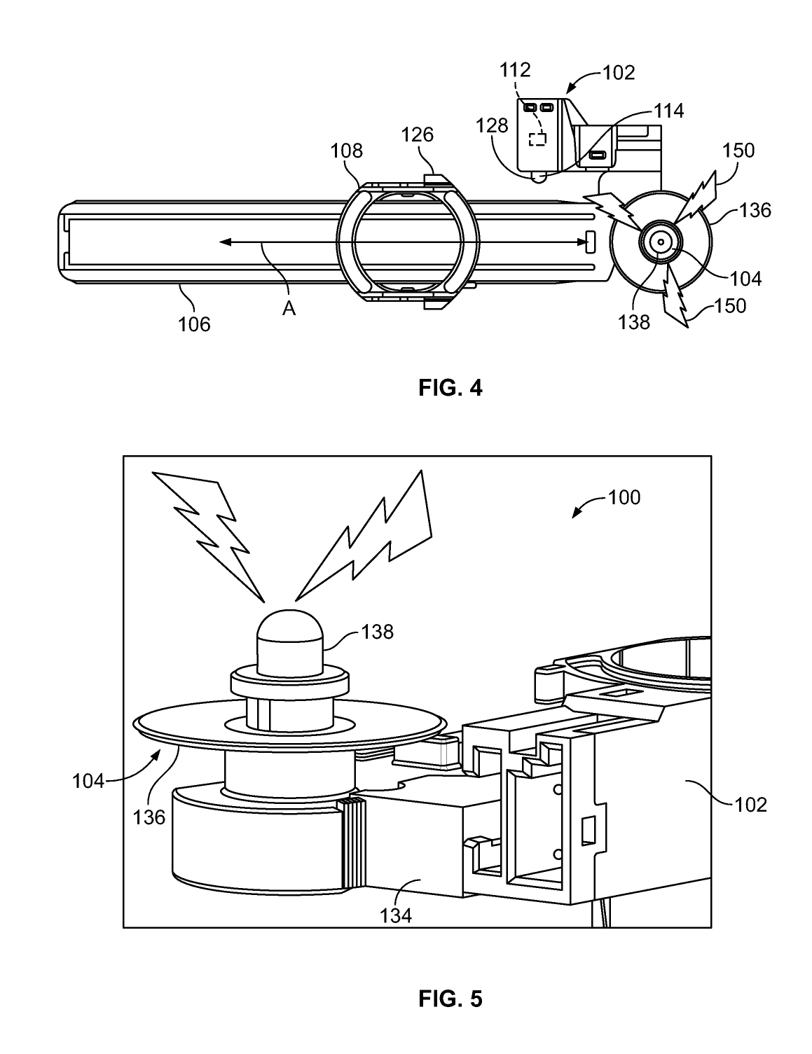

In operation, the carriage 108 is configured to move longitudinally over the rack 106 in the directions of arrows A. As the carriage 108 moves over the rack 106 away from the housing 102, as seen in FIG. 4, the protuberance 126 disconnects from the engagement portion 128 of the switch 114. In response, the switch 114 moves to a second or open position, in which the electrical circuit between the power source 112 and the lighting device 104 is closed and completed. As such, electrical power from the power source 112 is delivered to the lighting device 104, which thereby emits light from the light-emitting element 138.

FIG. 4 illustrates a front view of the damper assembly 100 in an open position, which corresponds to an open position of a component (such as a glove box) to which the damper assembly 100 is securely coupled.

FIG. 5 illustrates a perspective view of the lighting device 104 of the damper assembly 100. As shown, the light-emitting element 138 extends outwardly from the support base 136. The light-emitting element 138 may extend outwardly past the outer surface of the rack 106 and the carriage 108 (shown in FIGS. 1-4) in order to protrude into an interior chamber of a component (such as a glovebox). Optionally, the light-emitting element 138 may not extend into the interior chamber of the component. In this embodiment, the light-emitting element 138 may be recessed within a wall of the component and/or covered by a transparent cover of the component.

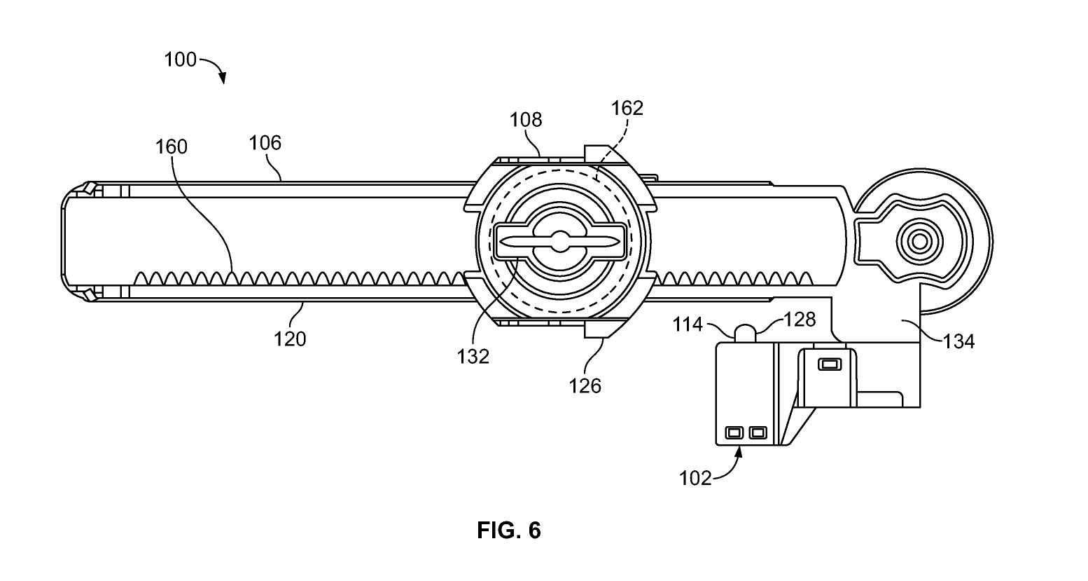

FIG. 6 illustrates a rear view of the damper assembly 100 in the open position. As indicated, the carriage 108 may include the fastening mount 132, such as a clip, that is configured to securely couple to a reciprocal portion of a fixed wall of a component. At least one of the tracks 120 may include teeth 160 that are configured to engage teeth of a rotor 162 (akin to a gear) within the inner body 130 of the carriage 108.

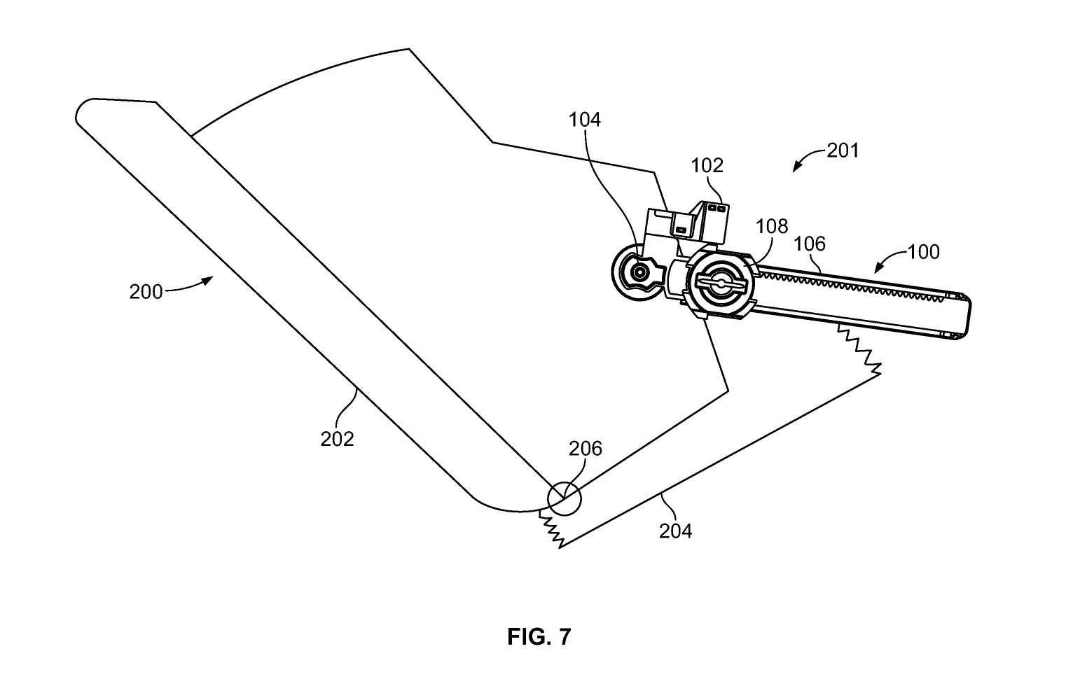

FIG. 7 illustrates an inner view of the damper assembly 100 secured to a component 200 in a closed position. The component 200 may be a glove box that includes a portion, such as a cover 202, which is moveably coupled to another portion, such as a fixed body/wall 204. For example, the cover 202 is configured to open and close in relation to the fixed wall 204 about a hinge 206. The carriage 108 may be secured to the fixed wall 204, while the rack 106 may be secured to the cover 202, or vice versa. The component 200 is or otherwise provides a system 201 that includes the cover 202, the fixed wall 204, and the damper assembly 100.

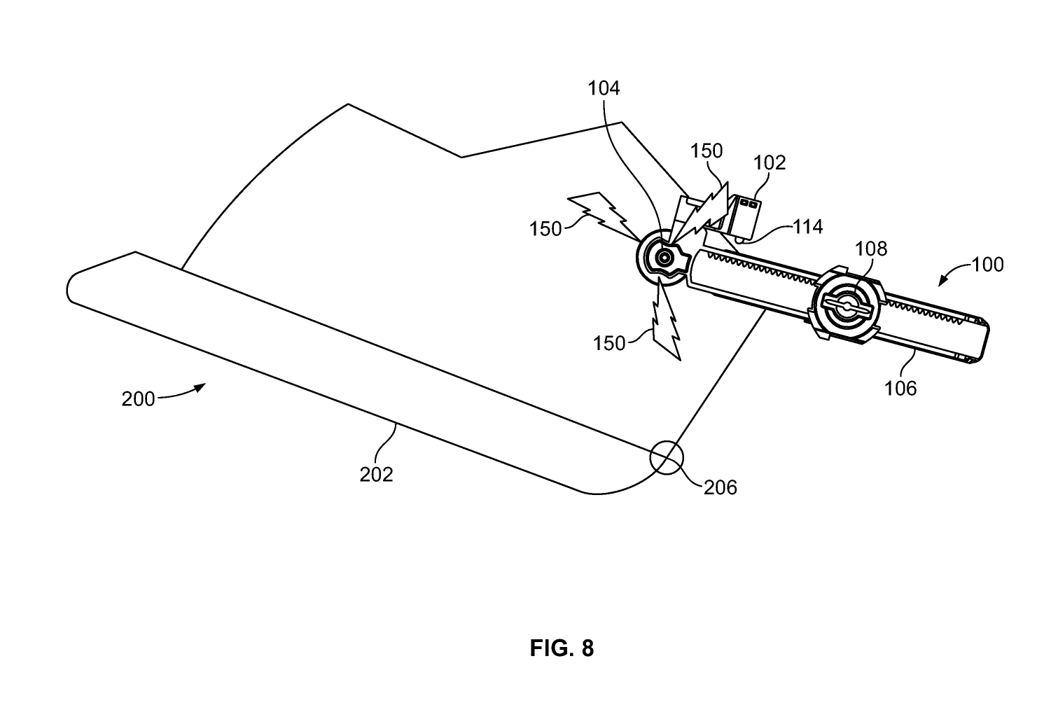

FIG. 8 illustrates an inner view of the damper assembly 100 secured to the component 200 in an open position. Referring to FIGS. 7 and 8, as the cover 202 is opened about the hinge 206, the carriage 108 moves over the rack 106 away from the housing 102, thereby disengaging the switch 114. In response, as explained above, electrical power from the power source 112 (shown in FIG. 1B, for example) is delivered to the lighting device 104, which thereby activates the lighting device 104 to emit light 150.

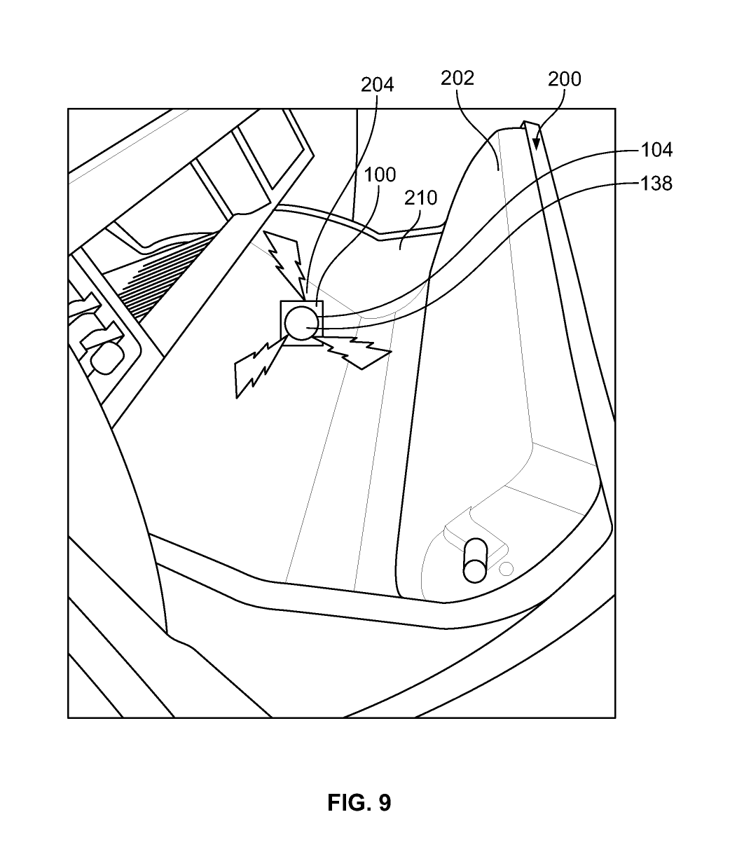

FIG. 9 illustrates a perspective view of the lighting device 104 of the damper assembly 100 within an interior chamber 210 of the component 200. As noted, the component 200 may be a glove box that includes the cover 202 pivotally secured to the fixed wall 204. The light-emitting element 138 may protrude into the interior chamber 210. When the cover 202 is opened, the lighting device 104 is activated to illuminate the interior chamber 210.

Referring to FIGS. 7-9, embodiments of the present disclosure provide a system 201 that includes the fixed wall 204, and the cover 202 moveably secured to the fixed wall 204. The cover 202 is configured to move between a closed position and an open position in relation to the fixed wall 204. The damper assembly 100 includes a damping mechanism (such as the rack 106 and the carriage 108) that is coupled to the fixed wall 204 and the cover 202. The damping mechanism is configured to dampen motion between the cover 202 and the fixed wall 204. The housing 102 is coupled to the damping mechanism. The housing 102 contains the power source 112. The lighting device 104 is coupled to the housing 102. The lighting device 104 is powered by the power source 112.

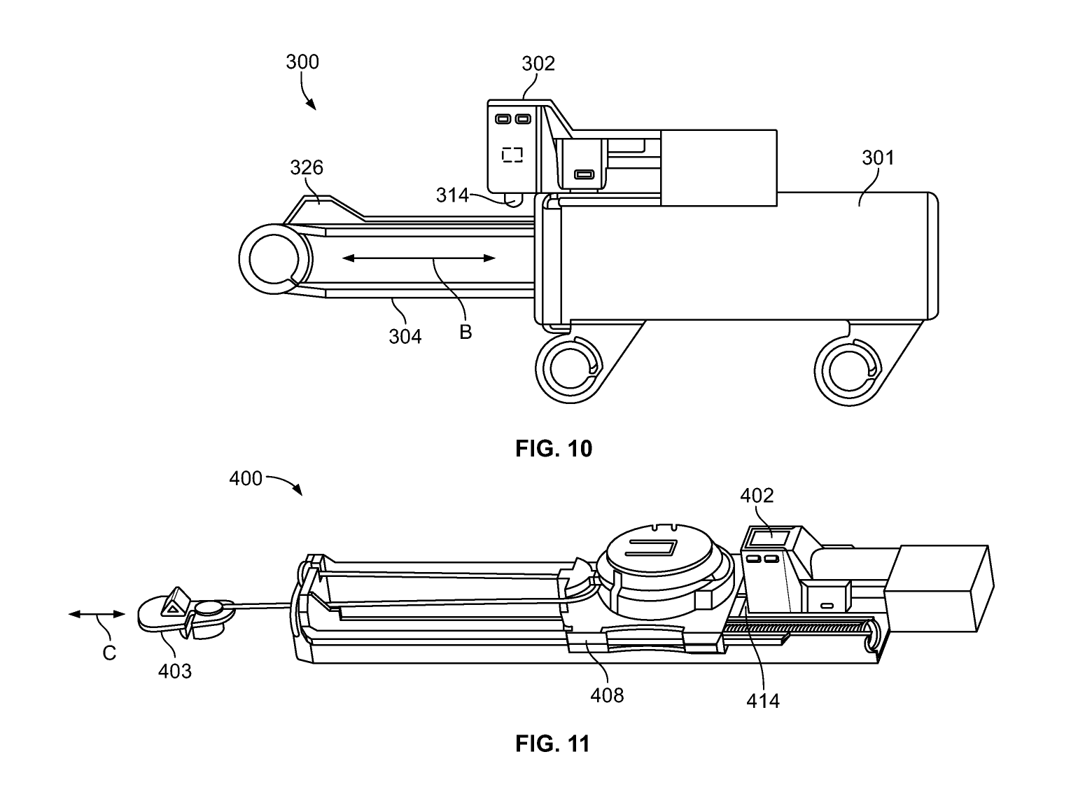

FIG. 10 illustrates a front view of a damper assembly 300, according to an embodiment of the present disclosure. The damper assembly 300 may be a pneumatic or air damper. The damper assembly 300 is similar to the damper assembly 100 described herein. For example, the damper assembly 300 includes a housing 302 having a switch 314. The damper assembly 300 may include or be coupled to a power source (such as the power source 112 shown in FIG. 1B) and/or a lighting device (such as the lighting device 104 shown in FIG. 1B). Instead of a carriage and a rack, the damper assembly 300 may include a retaining sleeve 301 that retains a moveable arm 304, which is configured to move into and out of the retaining sleeve 302 in the directions of arrows B. The arm 304 may include a protuberance 326 that is configured to engage the switch 314, as described above.

FIG. 11 illustrates a perspective front view of a damper assembly 400, according to an embodiment of the present disclosure. The damper assembly 400 may be a strand damper. The damper assembly 400 is similar to the damper assembly 100 described herein. For example, the damper assembly 400 includes a housing 402 having a switch 414. The damper assembly 400 may include or be coupled to a power source (such as the power source 112 shown in FIG. 1A) and/or a lighting device (such as the lighting device 104 shown in FIG. 1A). A carriage 408 may be moveably coupled to an anchor 403 (which may secured to a component) via a strand, such as a string, wire, and/or the like.

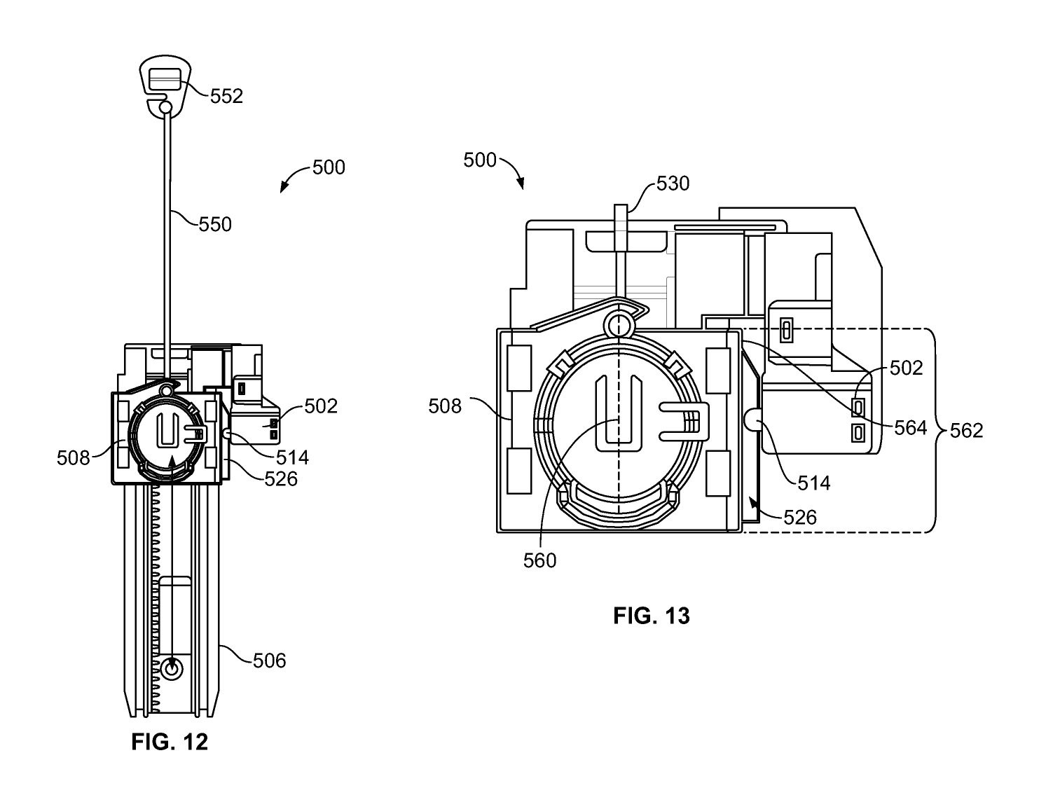

FIGS. 12 and 13 illustrate a damper assembly 500, according to an embodiment of the present disclosure. The damper assembly 500 includes a housing 502 having a switch 514, a rack 506, and a carriage 508 moveably coupled to the rack 506. The carriage 508 includes a protuberance, such as a ramp 526, extending outwardly from a side of the carriage 508. The ramp 526 is configured to engage a portion of the switch 514. The ramp 526 extends over a substantial length of a length 560 of the carriage 508. For example, the ramp 526 extends over more than half a length 562 of a side 564 of the carriage 508. In at least one embodiment, the ramp 526 may extend over the entire length 560 of the side 564 of the carriage 508. The relatively long length of the ramp 526 allows the switch 514 to be actuated at any point along the ramp 526.

The ramp 526 is an example of the protuberance 126 shown in FIG. 2, for example. Any of the embodiments described herein may include the ramp 526. For example, in FIG. 2, the ramp 526 may be the protuberance 126. The damper assembly 500 may include or be otherwise coupled to a power source, such as the power source 112, and/or a lighting device 104, as described above. As shown, the damper assembly 500 may be a strand damper having a tether or strand 550 (such as a string, wire, cable, or the like) that couples the carriage 508 to an anchor 552.

As shown, the switch 514 may be positioned on either side of the damper assembly 500. Accordingly, the ramp 526 may extend from either side of the carriage 508. In at least one embodiment, a ramp 526 may extend from both sides of the carriage 508. That is, the carriage 508 may include a first ramp 526 extending from a first side and a second ramp 526 extending from an opposite second side.

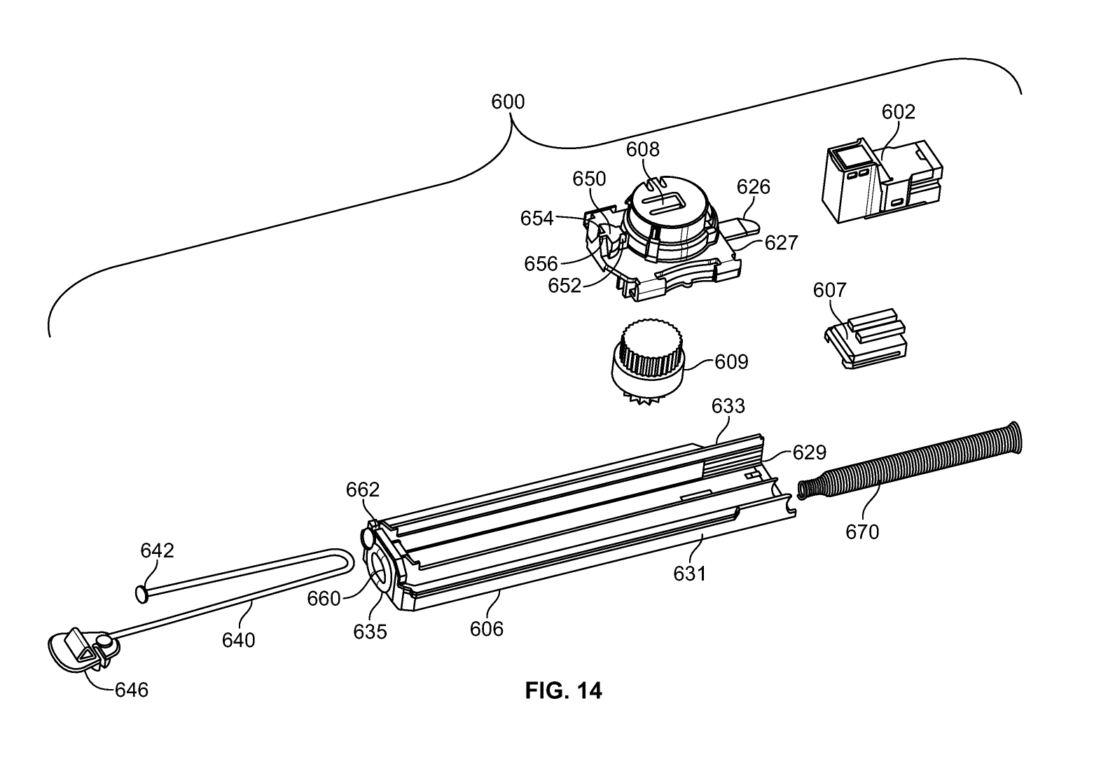

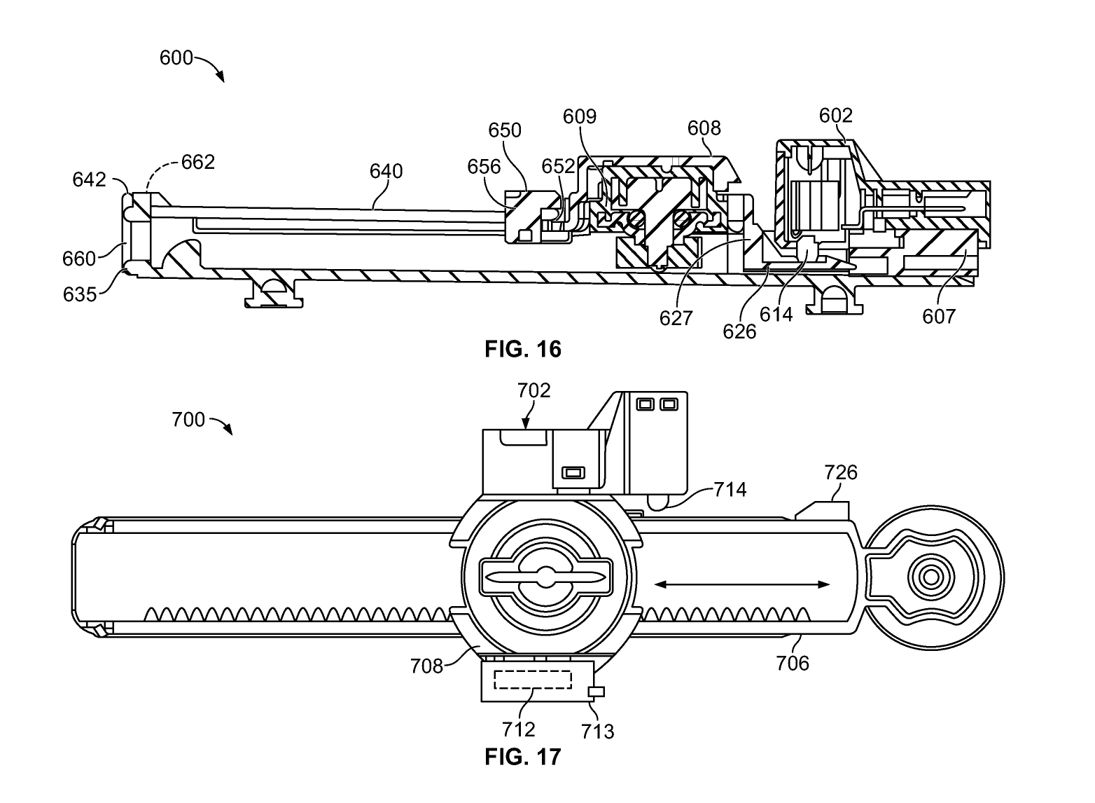

Referring to FIGS. 14-16, an embodiment of a damper assembly 600 includes a housing 602 that couples to a rack 606 through a clip 607. Optionally, the housing 602 may couple directly to the rack 606 without the clip 607. A carriage 608 is moveably coupled to the rack 606, for example, the carriage 608 may include an internal rotor 609 that is configured to engage the rack 606, such as in a gear-like fashion. A viscous fluid may be contained within the carriage 608 and may surround at least a portion of the rotor 609, for example. The carriage 608 interacts with the rack 606 to provide linear damping, for example. The rack 606 and the carriage 608 cooperate to provide a damping mechanism.

The carriage 608 may include a protuberance 626 extending from an end 627. The protuberance 626 may be an extension beam that is configured to engage a switch 614 of the housing 602, as described above. As shown, the housing 602 may be located proximate to an end 629 of the rack 606, instead of offset from a side 631 or 633 of the rack 606. Optionally, the housing 602 may be positioned on the side 631 or 633, and the protuberance 626 may extend from a side of the carriage 608.

A strand 640 having a first securing end 642 and a second anchoring end 644 secured to an anchor 646. The strand 640 extends through an end 635 of the rack 606. The end 635 of the rack 606 is opposite from the end 629 of the rack 606.

The carriage 608 further includes a strand coupler 650 that includes a first passage 652 separated from a second passage 654 by a central wall 656. The strand 640 extends through a channel 660 formed through the end 635 of the rack 606 and loops back through the strand coupler 650 via the first passage 652 and the second passage 654. The central wall 656 may be or otherwise include a pulley that moveably couples to the strand 640. The first securing end 642 securely locks into a reciprocal retainer 662 (such as a groove, slot, channel, recess, or the like) of the rack 606.

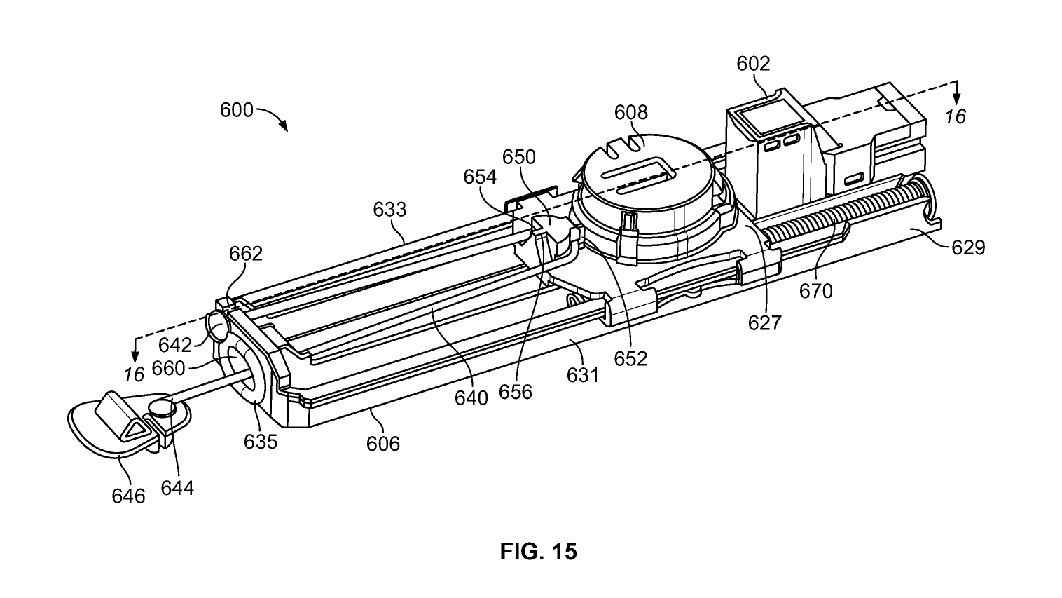

As shown in FIG. 15, in particular, the strand 640 loops back from the strand coupler 650, instead of being a single elongated coupling between the carriage 608 and the anchor 646 (in contrast to the embodiment shown in FIG. 12, for example). The strand coupler 650 provides a pulley-like coupling with the strand 640. The looped coupling of the strand 640 in relation to the strand coupler 650 shortens the stroke of the dampening mechanism, which allows for a shorter spring 670. That is, the spring 670 may deflect a shortened distance as compared to if the strand 640 did not loop back through the strand coupler 650. As such, the spring 670 is less susceptible to be over-stressed.

The damper assembly 600 may also include the spring 670 (such as a coil spring) that is retained within the rack 606. The spring 670 may be an extension spring that may be configured to exert a spring force towards the end 629 of the rack 606. In at least one embodiment, the spring 670 is configured to exert the spring force towards the end 629 of the rack 606, thereby biasing the protuberance 626 into the switch 614. In this manner, the spring 670 may drive actuation of the switch 614. The carriage 608 may be biased towards the end 635 away from the housing 602. The exerted resistive force of the spring 670 is overcome through relative motion between first and second components to which the damper assembly 600 is secured. Optionally, the damper assembly 600 may not include the spring 670.

The damper assembly 600 may be coupled to a power source (such as the power source 112 shown in FIG. 1A) and a lighting device (such as the lighting device 104 shown in FIG. 1A). In at least one embodiment, the damper assembly 100 may include the power source and/or the lighting device, as described above. In at least one embodiment, the damper assembly 600 is an example of the damper assembly 100 shown and described with respect to FIGS. 1A and 1B.

FIG. 17 illustrates a rear view of a damper assembly 700 in an open position. In this embodiment, the housing 702 may be coupled to the carriage 708. The switch 714 extends from the housing 702 and is configured to engage a protuberance 726 that extends from the carriage 706. The protuberance 726 may be sized, shaped, and configured similar to any of those described above. The housing 702 moves along with the carriage 708 as the carriage 708 moves over the rack 706.

Additionally, the power source 712 may be contained within the carriage 708. As shown, the power source 712 may be contained in a compartment 713 extending from the carriage 708. The compartment 713 may be on an opposite side of the carriage 708 from the housing 702. In at least one other embodiment, the power source 712 may be within the housing 702. A lighting device may be positioned at an end of the carriage 706. In at least one other embodiment, the lighting device may be coupled to the carriage 708, and/or the housing 702. In at least one other embodiment, the power source 712 may be contained within a portion of the carriage 706.

Referring to FIGS. 1-17, embodiments of the present disclosure provide damper assemblies, which may be configured to efficiently illuminate a component, such as a glovebox, when opened. Moreover, the damper assemblies may not be electrically coupled to a separate and distinct light through one or more wires. Further, the damper assemblies may not be electrically coupled to a separate and distinct power source through one or more wires.

In at least one embodiment, the damper assemblies provide an integral power source, one or more lights, and a damping mechanism. For example, a damper assembly (such as any of those shown and described with respect to FIGS. 1-17) includes an integral power source and a lighting device. The damper assembly is configured to be independently powered and independently emit light. Because the power source is contained within the housing of the damper assembly, there is no need to couple the damper assembly to a separate and distinct power source, for example. In this manner, the damper assembly allows for an efficient, simplified, and time-saving manufacturing process. The damper assembly is configured to independently provide motion-damping, power, and illumination.

In at least one other embodiment, the damper assembly may include the lighting device, and be coupled to a separate and distinct power source, such as separate and distinct battery within a vehicle. In this embodiment, the damper assembly may not include the integral power source. Optionally, the damper assembly may include the integral power source as a backup to the separate and distinct power source. In at least one other embodiment, the separate and distinct power source may be the backup in relation to the power source.

In at least one other embodiment, the damper assembly may include the integral power source, which is coupled to a separate and distinct lighting device within a component. The damper assembly may be independently powered through the power source and may be electrically coupled to the separate and distinct lighting device, which may be an existing lighting device within a glovebox, for example. In this embodiment, the damper assembly may not include a lighting device, but instead be coupled to a separate and distinct lighting device that is remote (that is, not on or within) the damper assembly. Optionally, the damper assembly may include the lighting device, as well as be coupled to a separate and distinct lighting device.

While various spatial and directional terms, such as top, bottom, lower, mid, lateral, horizontal, vertical, front and the like may be used to describe embodiments of the present disclosure, it is understood that such terms are merely used with respect to the orientations shown in the drawings. The orientations may be inverted, rotated, or otherwise changed, such that an upper portion is a lower portion, and vice versa, horizontal becomes vertical, and the like.

Variations and modifications of the foregoing are within the scope of the present disclosure. It is understood that the embodiments disclosed and defined herein extend to all alternative combinations of two or more of the individual features mentioned or evident from the text and/or drawings. All of these different combinations constitute various alternative aspects of the present disclosure. The embodiments described herein explain the best modes known for practicing the disclosure and will enable others skilled in the art to utilize the disclosure. The claims are to be construed to include alternative embodiments to the extent permitted by the prior art.

To the extent used in the appended claims, the terms “including” and “in which” are used as the plain-English equivalents of the respective terms “comprising” and “wherein.” Moreover, to the extent used in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

Various features of the disclosure are set forth in the following claims.

1. A system comprising:
a fixed body;
a cover moveably secured to the fixed body, wherein the cover is configured to be moved between a closed position and an open position in relation to the fixed body; and
a damper system comprising:
a damper assembly including a damping mechanism coupled to the fixed body and the cover, wherein the damping mechanism is configured to dampen motion between the cover and the fixed body, the damper assembly further including a housing coupled to the damping mechanism;
a switch;
a power source; and
a lighting device coupled to the power source, wherein a portion of the damping mechanism is configured to interact with the switch to activate and deactivate the lighting device.

2. The system of claim 1, wherein the damper assembly comprises the power source.

3. The system of claim 1, wherein the damper assembly comprises the lighting device.

4. The system of claim 1, wherein the damper assembly comprises the power source and the lighting device.

5. The system of claim 1, wherein the housing contains the power source.

6. The damper system of claim 5, wherein the lighting device is coupled to the housing, and wherein the lighting device is powered by the power source.

7. A damper system comprising:
a damper assembly including a damping mechanism that is configured to dampen motion between a first portion and a second portion of a component, and a housing coupled to the damping mechanism and a switch;
a power source;
a switch; and
a lighting device coupled to the power source, wherein a portion of the damping mechanism is configured to interact with the switch to activate and deactivate the lighting device.

8. The damper system of claim 7, wherein the damper assembly comprises the power source.

9. The damper system of claim 7, wherein the damper assembly comprises the lighting device.

10. The damper system of claim 7, wherein the damper assembly comprises the power source and the lighting device.

11. The damper system of claim 7, wherein the housing contains the power source.

12. The damper system of claim 11, wherein the lighting device is coupled to the housing, and wherein the lighting device is powered by the power source.

13. The damper assembly of claim 7, wherein the lighting device is configured to be activated to emit light when the first portion is opened in relation to the second portion, and wherein the lighting device is configured to be deactivated when the first portion is closed in relation to the second portion.

14. The damper assembly of claim 7, wherein the damping mechanism comprises:
a rack that is configured to be secured to one of the first portion or the second portion; and
a carriage moveably secured to the rack, wherein the carriage is configured to be secured to the other of the first portion or the second portion.

15. The damper assembly of claim 14, wherein the switch extends from the carriage.

16. The damper assembly of claim 14, further comprising an extension spring within the rack, wherein the extension spring is configured to drive actuation of the switch.

17. The damper assembly of claim 14, further comprising a strand coupled to the carriage and an anchor that is configured to be secured to the other of the first portion of the second portion.

18. The damper assembly of claim 17, wherein the carriage comprises a strand coupler including a first passage separated from a second passage by a wall, wherein the strand loops through the first passage and the second passage.

19. The damper assembly of claim 14, wherein the carriage comprises a ramp outwardly extending from a side of the carriage, wherein the ramp is configured to engage a portion of the switch.

20. The damper assembly of claim 19, wherein the ramp extends over more than half a length of a side of the carriage.
